(19) United States
(12) Patent Application Publication
(10) Pub. No.: US 2003/0145636 A1
(43) Pub. Date: Aug. 7, 2003

(54) Zipper locking device and method of locking a zipper

(76) Inventor: Cory O. Nykoluk, St. Louis, MO (US)

Correspondence Address: Clyde L. Smith, Thompson Coburn LLP, One Firstar Plaza, Suite 3500, St. Louis, CO, 63101, US

(21) Appl. No.: 10/068,060

(22) Filed: Feb. 5, 2002

(51) Int. Cl. E05B 67/38

(52) U.S. Cl. 70/68

(57) ABSTRACT

A zipper locking device comprises a zipper, a zipper slider, and a locking member. The zipper slider and the locking member each have loops formed thereon. The locking member is attached to an article adjacent an end of the zipper and is configured such that one of the loops can be passed at least partially through the other of the loops in a manner such that a lock can then be used to secure the loops together. With the loops secured together, the zipper slider becomes locked to the locking member and the zipper cannot be opened.

### BACKGROUND OF THE INVENTION

This invention pertains to the field of zipper locking devices and methods of locking zippers. More particularly, this invention pertains to a locking member that has a loop and that is positioned at one end of a zipper assembly. The loop of the locking member cooperates with a loop provided on the slider of the zipper assembly by passing one of the loops at least partially through the other of the loops to allow a bolt of a lock to then be use to secure the loops together so as to limit the movement of the slider along the zipper. The invention provides a simple and cost effective means for locking a zipper.

Description of the Related Art

Numerous devices utilize zippers for releasably securing portions of such devices together. With many types of such devices, it is desirable to be able to lock the zipper in a closed position so as to prevent unauthorized persons from opening the zipper. This is especially true in the case of baggage, which often utilize zippers to gain and prevent access to interior compartments thereof and that must also frequently be left unattended.

As a result of the need for preventing unauthorized access to the contents of various articles of baggage, numerous locking devices have been developed for locking zippers in a closed position. One of the more successful devices has been the use of what are know in the art as “kissing” zipper sliders. Kissing zipper sliders are zipper sliders that that can be locked together by a small padlock. By placing two kissing zipper sliders on a single zipper in an orientation such that the portion of the zipper between the sliders is open and such that the remaining portion(s) of the zipper is(are) closed, the zipper sliders can be brought together at any location along the length of the zipper to close the zipper. Thus, when such kissing zipper sliders are then locked together, the zipper is effectively locked in a closed position.

Perhaps the most common type of kissing zipper sliders comprises a pair of identical zipper sliders. Each of the zipper sliders is provided with a small loop that is usually oriented such that the loop lies generally in a plane that is perpendicular to the plane of the zipper and parallel to the length thereof. By positioning the loop of each of the sliders at the end of the slider that is closest to the other of the sliders along the length of the zipper and by slightly offsetting the loop from the centerline of the slider, the loops overlap each other and are aligned with each other when the sliders are engaged with each other. In this position, the U-shaped bolt of a miniature padlock or a cable style bolt of a lock can be positioned through the loop of each of the sliders simultaneously to lock the sliders together.

While kissing zipper sliders provide a relative simple way of locking a zipper in a closed position, there are also disadvantages associated with such locking devices. In particular, due to the fact that kissing zipper sliders can be locked together at any location along a zipper, it often takes a person a brief moment to locate the sliders along the zipper's length. This is especially the case when such sliders are utilized on baggage, due to the fact that the such zippers typically extend around a substantial majority of the periphery such baggage and, as a result, the sliders are often not visible from any particular side of the baggage.

### SUMMARY OF THE INVENTION

The present invention overcomes the disadvantages associated with prior art zipper locking devices and methods of locking zippers by providing a locking member comprising a loop at one end of a zipper assembly. The loop of the locking member cooperates with a loop provided on the slider of the zipper assembly by passing one of the loops at least partially through the other of the loops to allow a bolt of a lock to then be use to secure the loops together. With the loops secured together, the locking member limits the movement of the slider along the zipper and thereby locks the zipper in a closed position. Utilizing the present invention, the zipper assembly needs only have one slider and such a slider can be predictably located when the zipper is in the closed position.

In general, a zipper locking device of the present invention comprises a zipper, a slider, and a locking member. The zipper of the zipper locking device comprises two rows of teeth and is selectively and alternatively adjustable between open and closed positions. In the closed position, the rows of teeth are intermeshed with each other. In the open position, the rows of teeth are separated from each other for a substantial portion of the length of the zipper.

The slider of the zipper locking device of the present invention is slidably connected to the zipper in a manner such that the slider is movable between first and second positions along the rows of teeth. As the slider is moved from the first position to the second position, the slider intermeshes the two rows of teeth of the zipper together. Conversely, as the slider is moved from the second position to the first position, the slider separates the rows of teeth of the zipper from each other. The slider also preferably comprises a main body and a locking loop.

The locking member of the zipper locking device of the present invention is operatively connected to the zipper and also preferably comprises a loop. The locking member is positioned adjacent an end of the zipper. The loop of the locking member is dimensioned such that either the loop of the slider or the loop of the locking member can, at least partially, pass through the other of the loops when the slider is in the second position. In such a position, a bolt of a lock can then be positioned extending through the loop that has been passed at least partially through the other loop. With the bolt of the lock attached thereto, the loop that has been passed at least partially through the other loop can no longer be passed back therethrough and the movement of the slider toward its first position is limited, thereby locking the zipper in its closed position.

In general, the method of locking a zipper in a closed position in accordance with the present invention comprises, providing a zipper that is selectively and alternatively adjustable between open and closed positions and that comprises two rows of teeth. In the closed position, the rows of teeth are intermeshed with each other. In the open position, the rows of teeth are separated from each other for a substantial portion of the length of the zipper.

The method of the present invention also comprises providing a slider that is slidably connected to the zipper in a manner such that the slider is movable between first and second positions along the rows of teeth. As the slider is moved from the first position toward the second position, it intermeshes the rows of teeth together to thereby close the zipper. Conversely, when the slider is moved from the first position toward the second position, it separates the rows of teeth from each other to thereby open the zipper. The slider also comprises a main body and a loop.

The method of the present invention further comprises providing a locking member that is operatively connected to the zipper and that comprises a loop, positioning the slider in the second position, and thereafter passing at least a portion of the loop of either the slider or the locking member through the other of the loops. Finally, the method further comprises positioning the bolt of a lock extending through the portion of the loop that has been passed through the other such that the bolt prevents the portion of the loop that has been passed through the other from passing back therethrough. This limits the slider from moving toward the first position and thereby locks the zipper in its closed position.

While the principle advantages and features of the invention have been described above, a more complete and thorough understanding of the invention may be obtained by referring to the drawings and the detailed description of the preferred embodiment, which follow.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a perspective view of a piece of baggage provided with the zipper locking device of the preferred embodiment of the invention, shown with the zipper in an open position;

FIG. 2 is a perspective view of the preferred embodiment of the zipper locking device of the invention, shown with the zipper between the fully closed and fully open positions; and

FIG. 3 is a perspective view of the preferred embodiment of the zipper locking device of the invention, shown with the zipper in the closed position and with a bolt of a lock passed through the loop of the zipper slider.

Reference characters in the written specification indicate corresponding parts throughout the several views of the drawings.

### DETAILED DESCRIPTION OF THE PREFERRED EMBODIMENT

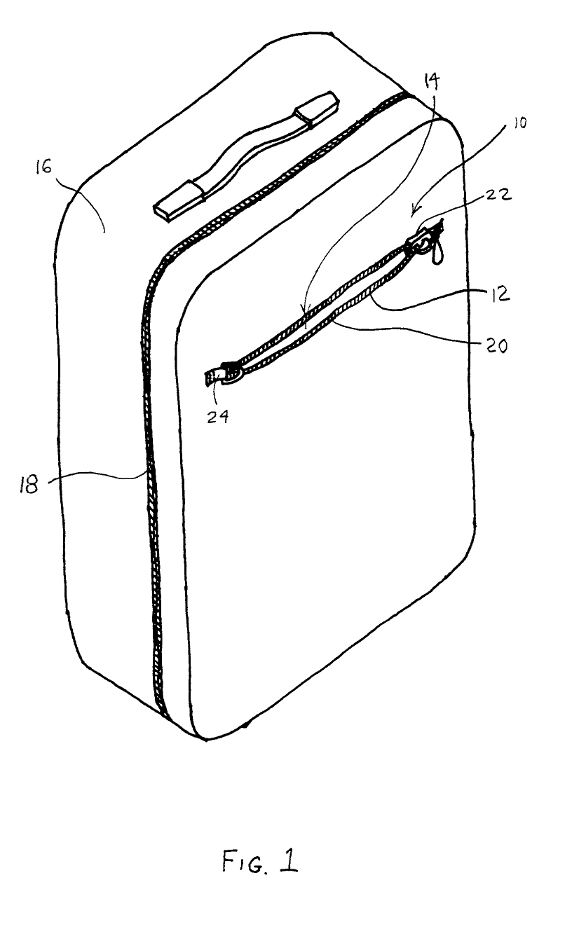

The preferred embodiment of the zipper locking device of invention is preferably utilized in connection with articles of baggage. As illustrated in FIG. 1, the zipper locking device 10 is shown attached to the opening 12 of a side compartment 14 of a piece of baggage 16. Additionally, although not shown, the zipper locking device 10 is also preferably utilized on all openings of the piece of baggage 16, such as the main compartment opening 18.

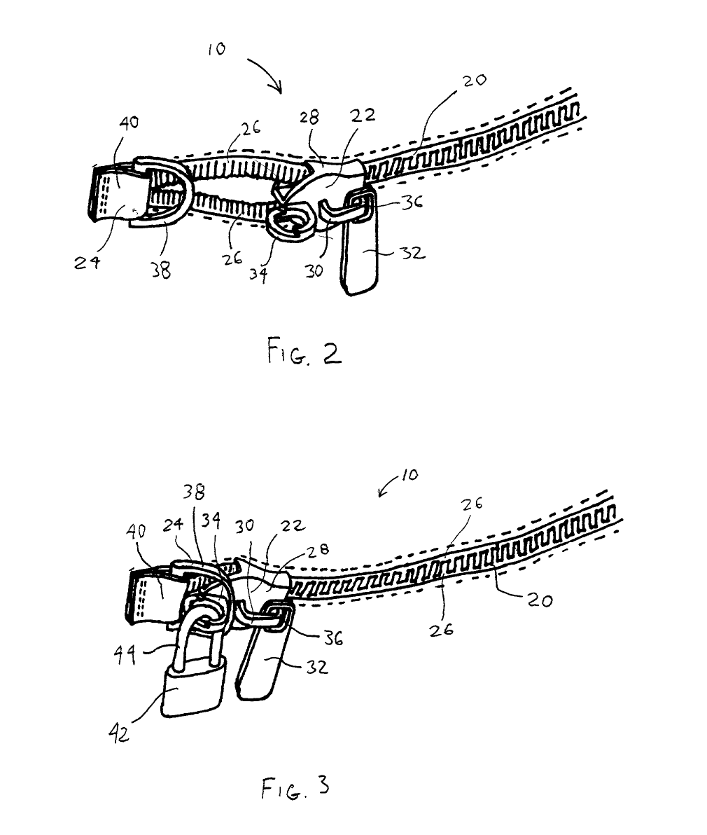

As shown more clearly in FIGS. 2 and 3, the preferred embodiment of the zipper locking device 10 comprises a zipper 20, a zipper slider 22, and a locking member 24. The zipper 20 is preferably a standard type of commonly available zipper and is preferably formed of fabric, plastic, metal, or some combination thereof. Two rows of teeth 26 extend along the length of the zipper 20 and are selectively intermeshable with and separable from each other using the zipper slider 22. It should be appreciated that the details of exactly how various zippers and sliders are configured and how they cooperate with each other to selectively intermesh and separate the zipper teeth are well known in prior art and, for this reason, are not discussed in this specification.

The zipper slider 22 of the preferred embodiment is preferably formed of metal and is preferably identical to a prior art kissing zipper slider. Generally, the zipper slider 22 comprises a main body 28, a pull tab loop 30, a pull tab 32, and a locking loop 34. The main body 28 of the slider 22 is configured and adapted to connect to and slide along the length of the zipper 20 in a manner such that it intermeshes or separates the rows of teeth 26 of the zipper, depending on which direction the slider is moved relative to the zipper. The pull tab loop 30 is preferably integrally formed with the main body 28 as an open loop. The pull tab 32 is preferably formed separate from the remainder of the slider 22 and is preferably formed of metal or plastic. An opening 36 formed through the pull tab 32 allows the pull tab to be connected to the main body 28 of the slider 22 by passing the open pull tab loop 30 therethrough. Once this is done, the pull tab loop 30 is typically crimped slightly to further close the pull tab loop such that the pull tab 32 cannot be removed from the pull tab loop. The locking loop 34 of the slider 22 is preferably formed as a closed loop that is integral with the main body 28 of the slider and is preferably oriented in a plane that is perpendicular to the plane defined by the rows of teeth 26 of the zipper 20 and that is parallel to the sliding direction of the slider along the zipper.

The locking member 24 of the preferred embodiment preferably comprises a metal loop 38 and a fabric tether 40. The loop 38 of the locking member 24 is preferably D-shaped and is preferably a closed loop. The tether 40 is preferably formed as a rectangular piece of ballistic nylon or leather that is folded around the straight portion of the D-shaped loop 38. The tether 40 is preferably sewn or riveted to the article on which the zipper 20 is attached directly adjacent the end of the zipper that opens first, as shown. Preferably, the tether 40 and the loop 38 of the locking member 24 are configured such that the loop extends adjacent the end of the zipper 20 in an overlapping manner. Configured in shown and described, the loop 38 of the locking member 24 is secured to the article by the tether 40 and is free to pivot about an axis that is perpendicular to the locking loop 34 of the zipper slider 22.

Having described the various components of the zipper locking device 10 of the preferred embodiment of the invention, its use will now be described. In use, the zipper 20 and slider 22 of the zipper locking device 10 function identically to prior art zippers and sliders by allowing the zipper to be selectively opened and closed in response to the movement of the slider along the length of the zipper. However, when desired, the zipper locking device 10 can be used in conjunction with a conventional baggage lock, such as a small padlock 42 as shown in FIG. 3, to secure the zipper 20 in its closed position. To do this, the slider 22 is moved along the zipper 20 as far as possible toward the locking member 24, thereby closing the zipper. As this is done, the loop 38 of the locking member 24 is pivoted away from the plane of the zipper 20 to allow the locking loop 34 of the slider 22 to be positioned between the loop of the locking member and the zipper. With the locking loop 34 of the slider 22 positioned between the loop 38 of the locking member 24 and the zipper 20, the loop of the locking member is then pivoted back toward the zipper. The loop 38 of the locking member 24 is dimensioned slightly larger than the locking loop 34 of the slider 22 such that the locking loop of the slider passes partially through the loop of the locking member as the loop of the locking member is pivoted back toward the zipper 20. Once this is done, a lock 42 is attached to the locking loop 34 of the slider 22 with the loop 38 of the locking member 24 being positioned between the lock and the main body 28 of the slider. The lock 42 is attached to the locking loop 34 of the slider 22 by passing the bolt 44 of the lock therethrough and then closing the lock. It is important to appreciate that the loop 38 of the locking member 24 is dimensioned such that the lock 42 cannot pass therethrough when the lock is attached to the slider 22. Once these steps have been performed, the zipper slider 22 cannot be separated from the locking member 24 and, as a result, the zipper 20 is locked in its closed position. To unlock the zipper 20, the lock 42 is first removed from the locking loop 34 of the slider 22 and then the above mentioned steps are simply reversed.

As various modifications could be made in the constructions and methods herein described and illustrated without departing from the scope of the invention, it is intended that all matter contained in the foregoing description or shown in the accompanying drawings shall be interpreted as illustrative rather than limiting. For example, the locking loop of zipper slider needs not necessarily be a closed loop and could be formed as a partially open loop so long as it could still retain a lock. Additionally, the slider need not necessarily have a pull tab or a pull tab loop. Furthermore, the lock used with the invention could be any type of lock, such as a cable style lock, and needs not be a padlock. Finally, when introducing elements of the present invention or the preferred embodiment(s) thereof, the articles “a,” “an,” “the” and “said” are intended to mean that there are one or more of the elements. The terms “comprising,” “including” and “having” are intended to be inclusive and mean that there may be additional elements other than the listed elements. Thus, the breadth and scope of the present invention should not be limited by any of the above-described exemplary embodiments, but should be defined only in accordance with the following claims appended hereto and their equivalents.

What is claimed:

1. A zipper locking device comprising:
a zipper that is selectively and alternatively adjustable between an open position and a closed position, the zipper having a length and comprising two rows of teeth, the rows of teeth being intermeshed with each other when the zipper is in the closed position and being separated from each other for a substantial portion of the length of the zipper when the zipper is in the open position;
a slider that is slidably connected to each of the rows of teeth such that the slider is movable between first and second positions along the rows of teeth, the slider being configured and adapted to intermesh the rows of teeth together when the slider is moved from the first position to the second position and to separate the rows of teeth from each other when the slider is moved from the second position to the first position such that the zipper is in the open position when the slider is in the first position and such that the zipper is in the closed position when the slider is in the second position, the slider comprising a main body and a loop; and
a locking member that is operatively connected to the zipper, the locking member comprising a loop, one of the loops of the slider and the locking member constituting a first loop and the other of the loops constituting a second loop, the first loop being adapted and configured to be at least partially passable through the second loop when the slider is in the second position and being configured and adapted to allow a bolt of a lock to be positioned extending therethrough, the second loop being configured and adapted to prevent the passage of the first loop through the second loop when the bolt of the lock is positioned extending through the first loop such that the movement of the slider towards the first position is limited when the bolt of the lock is positioned extending through the first loop.

2. A zipper locking device in accordance with claim 1 wherein the first loop is the loop of the slider and the second loop is the loop of the locking member.

3. A zipper locking device in accordance with claim 2 wherein the loop of the locking member is rigid.

4. A zipper locking device in accordance with claim 1 wherein the loop of the slider is integrally formed as a monolithic piece together with the main body of the slider.

5. A zipper locking device in accordance with claim 1 wherein the slider further comprises a pull loop and a pull tab, the pull tab being pivotally connected to the pull loop of the zipper in a manner such that the pull tab is movable relative to main body of the slider.

6. A zipper locking device in accordance with claim 1 wherein the loop of the slider is a closed loop.

7. A piece of baggage comprising a zipper locking device in accordance with claim 1.

8. A method of locking a zipper in a closed position comprising:
providing a zipper that is selectively and alternatively adjustable between an open position and a closed position, the zipper having a length and comprising two rows of teeth, the rows of teeth being intermeshed with each other when the zipper is in the closed position and being separated from each other for a substantial portion of the length of the zipper when the zipper is in the open position;
providing a slider that is slidably connected to each of the rows of teeth such that the slider is movable between first and second positions along the rows of teeth, the slider being configured and adapted to intermesh the rows of teeth together when the slider is moved from the first position to the second position and to separate the rows of teeth from each other when the slider is moved from the second position to the first position such that the zipper is in the open position when the slider is in the first position and such that the zipper is in the closed position when the slider is in the second position, the slider comprising a main body and a loop;
providing a locking member, the locking member being operatively connected to the zipper and comprising a loop, one of the loops of the slider and the locking member constituting a first loop and the other of the loops constituting a second loop;
providing a lock comprising a bolt;
sliding the slider to the second position such that the zipper is in the closed position;
passing at least a portion of the first loop through the second loop when the slider is in the second position; and
positioning the bolt of the lock in a manner such that the bolt extends through the portion of the first loop and such that the bolt prevents the portion of the first loop from passing back through the second loop so as to limit the slider from moving from the second position toward the first position.

9. A method of locking a zipper in a closed position in accordance with claim 8 wherein the loop of the slider is rigidly fixed to the main body of the slider and wherein the step of passing at least the portion of the first loop through the other of the loops further comprises passing at least a portion of the loop of the slider through the loop of the locking member.

10. A method of locking a zipper in a closed position in accordance with claim 9 wherein the loop of the locking member is pivotal about an axis relative to the zipper and wherein the step of passing at least the portion of the first loop through the second loop further comprises pivoting the loop of the locking member about the axis to cause the portion of the loop of the slider to pass through the loop of the locking member.

11. A method of locking an opening of an internal compartment of a piece of baggage in a closed position comprising:
providing a piece of baggage comprising an internal compartment having an opening that connects the internal compartment to an environment external to the piece of baggage; and
locking the opening of the internal compartment of the piece of baggage by performing the method of locking a zipper in a closed position in accordance with claim 8.
